(19) United States
(12) Patent Application Publication
(10) Pub. No.: US 2005/0117114 A1
(43) Pub. Date: Jun. 2, 2005

(54) Revolutionary method in optical system design

(76) Inventor: Jianfeng Jiang, San Jose, CA (US)

Correspondence Address: Jianfeng Jiang, 1149 EL Prado Dr., San Jose, CA, 95120, US

(21) Appl. No.: 10/725,114

(22) Filed: Dec. 2, 2003

(51) Int. Cl. G02C 7/02

(52) U.S. Cl. 351/177

(57) ABSTRACT

A revolutionary method in optical system design uses the digital-signal-processing power of image chips to correct the aberrations of the lens, thereby reducing the number of lens required. The optical module (including lens and image chip) built this way will be cheaper and smaller.

### FIELD OF INVENTION

This invention relates to optical system design, more specifically to lens design, image chip design and lens module design.

### BACKGROUND OF THE INVENTION

Optical systems are increasingly penetrating into our everyday life. Digital Cameras, Projectors, Camcorders, and new generations of cellular phones with cameras, just to name a few common products.

A typical optical system consists of a set of lens and an image chip.

The image chip is typically made of either CCD (charge-coupled-device) or CMOS (complementary-Metal-Oxide-Semiconductor). It senses the image formed by the lens set and converts it into electrical signals (either analog or digital).

The lens is made of plastics or glass with spherical or aspherical surface, it bends the light from the object and forms an image at the image plane. Plastic lens is very cheap but of less quality. Glass lens is used for optical systems with higher resolution and less temperature-related distortions. Glass lens is more expensive than plastic lens. Lens with spherical surface is much easier to manufacture and much cheaper than lens with aspheical surface.

There is no lens set that can form an exact image of the object, aberrations are always present in the images. For example, if the object is a point light source, its image will not be a point, rather the image will be a haze surrounding a bright point. The image of a point object is called Point-Spread-Function (PSF). The aberrations of lens are usually classified as: Spherical Aberration, Coma, Astigmatism, Distortion and Chromatic Aberrations. The Point-Spread-Function (PSF) contains all of these informations.

As shown in FIG. 1, If the optical system is rotationally symmetrical about the optical axis which is practically the case, then a ray of light from the point (y=h, x=0) in the object that passes through the lens at a point defined by its polar coordinates (s, 0) will intersect the image surface at (x′, y′) in the general forms as follows:
Y′=A₁S cos θ+A₂h+B₁S³ cos θ+B₂S²h(2+cos 2θ)+(3B₃+B₄)sh² cos θ+B₅h³+C₁S⁵ cos θ+(C₂+C₃ cos 2θ)s⁴h+(C₄+C₆ cos ²θ)s³h² cos θ+(C₇+C₈ cos 2θ)s²h³+C₁₀sh⁴ cos θ+C₁₂h⁵+D₁S⁷ cos θ+ (1)
X′=A₁s sin θ+B₁S³ sin θ+B₂s²h sin 2θ+(B₃+B₄)sh² sin θ+C₁s⁵ sin θ+C₃s⁴h sin 2θ+(C₅+C₆ cos ²θ)s³h² sin θ+C₉s²h³ sin 2θ+C₁₁sh⁴ sin θ+D₁s⁷ sin θ+ (2)

The objective of lens design is to choose from different glass material, choose the number of lens, the shape and size of each lens, so that the whole lens set meets the specifications including focal length, view angle, resolution, distortion, etc.

Traditionally, the lens design and image chip design are two independent processes done by independent companies. The lens designers optimize the lens design to achieve as less aberrations and distortions as possible, which usually results in many lens in high resolution systems (typically 3 to 12 lens). To reduce the number of lens, some manufacturers use aspherical lens (non-spherical surface) which is very expensive. On the other hand, the rapid advance in VLSI technology makes the digital-signal-processing capability of image chips very high with little cost. It is foreseeable that as technology advances, the resolution requirements of the lens system are increasingly higher which will put lots more burdens on the lens design. The essence of the invention is to make full use of the powerful digital-signal-processing-capability of the image chip to correct some aberrations of the lens set, thus reduce the aberration requirements for the lens design. By doing this, the number of required lens is reduced and the overall cost of the optical systems (lens+image chip) is reduced. That is, smaller and cheaper optical system can be achieved using this invention.

### SUMMARY OF THE INVENTION

The invention is about the optimization of the optical system design (including both lens and image chip). Using the proposed design method for both lens and image chips, higher resolution with less cost and smaller size are possible.

Firstly, for existing lens, the Point-Spread-Functions of selected object points are measured (Refer to FIGS. 3, 4, 5 & 6 for the setup) with a high resolution image sensor. Note that in order to extract as much information as possible about the lens, the PSF corresponding to three colors (typically Red, Blue or Green) are measured separately, since most of the image chips have intermingled color filters. Once all the PSF are measured, the parameters describing the lens aberrations can be extracted. Using a mathematical technique called deconvolution or other techniques, the aberrations caused by the lens can be corrected using the proposed image chips (will be described later). Thus, the existing lens design can be re-used for higher resolution optical systems with a higher-resolution image chip with proposed correction capability. In this way, considerable costs of lens re-design are saved for higher resolution optical systems.

Secondly, for optical systems of which the lens must be re-designed, much less cost and smaller size optical systems can be achieved by relaxing the aberration requirements on the lens system, that is, less number of lens can be used to achieve the desired high resolution using the proposed error correction techniques. This is extremely useful for cell-phones cameras, in which the camera must be made as small as possible.

Theoretically, the proposed aberration correction technique can be proven as follows.

As shown in FIG. 2 (without loss of generality, a two-dimentional case is illustrated.) If the object is a vertical line with M point light sources with equal intensity, and there are N pixels on the image chip. For each point light source, its image is a Point-Spread-Function which will look like a haze surrounding a bright spot. So long as the lens aberrations are not too big, the size of the Point-Spread-Function should be really small.

For each object point i, its intensity at image point j can be denoted as Sᵢⱼ, where Sᵢⱼ is a representation of the Point-Spread-Function.

For an arbitrary object, if the illuminance of the i-th object point is denoted by Oᵢ, its image at j-th pixel is denoted by Iⱼ, then using matrix format, the lens system can be described as:

$$[ \begin{matrix}{I}_{1} \\ {I}_{2} \\ {I}_{3} \\ ⋮ \\ {I}_{n}\end{matrix} ] = [ \begin{matrix}{S}_{11} & {S}_{12} & {S}_{13} & ⋯ & {S}_{1 m} \\ {S}_{21} & {S}_{22} & {S}_{23} & ⋯ & {S}_{2 m} \\ {S}_{31} & {S}_{32} & {S}_{33} & ⋯ & {S}_{3 m} \\ ⋮ & ⋮ & ⋮ & ⋮ & ⋮ \\ {S}_{n1} & {S}_{n2} & {S}_{n3} & ⋯ & {S}_{nm}\end{matrix} ] * [ \begin{matrix}{O}_{1} \\ {O}_{2} \\ {O}_{3} \\ ⋮ \\ {O}_{m}\end{matrix} ]$$

Or to write it concisely in vector form:
I=S*O (3)
Where I is a vector with n elements denoting the intensity at each image point,
O is a vector with m elements denoting the intensity at each object point,
And S is the matrix characterizing the transformation from object points to image points, which contains the Point-Spread-Function of all the points.

Ideally, for a perfect lens system, the S matrix is a unit matrix, that is, every object points corresponds to one image point. In reality the images are somewhat blurred.

If the lens aberrations are not too big, then the S matrix will be a sparse matrix, that is, there are only a few non-zero elements. For example, the first column stands for the Point-Spread-Function of the first object point. If the point-spread-function covers only 5 images points, then only the first 5 elements are non-zero.

Theoretically once S matrix is extracted from measurements, then for any light source, its true image can be derived from
O=S⁻¹*I. Where S⁻¹ is the inverse matrix of the S matrix. (4)

It should be noted that for different wave length lights, the S matrix will be slightly different because of the lens aberrations.

This is the essence of the invention, use some pre-designed object (one example is shown in FIGS. 3&4, Of which there are many nearly-point-like light sources), measure the Point-Spread-Functions using very high resolution image chips, do the measurement for Red, Green and Blue lights, the S matrix is thus extracted. And the inverse matrix S⁻¹ can also be calculated and the result will be stored in the proposed image chip, the proposed image chip will do a simple conversion according to formulae (3) & (4) to achieve a good image with the lens aberrations corrected.

Another example of measuring the Point-Spread-Function of the lens is shown in FIGS. 5 &6, where we can approximate the PSF by a circular distribution with radius ε, by measuring the images of evenly separated circular sources as shown in FIG. 5, the radius ε can be calculated as:
ε=Ri−(Li/Lo)*Ro

It should also be pointed out that by using both the measured S-matrix and the theoretical lens aberrations formulae (1) & (2), some faster image correction algorithms are possible.

### DESCRIPTION OF THE DRAWINGS

FIG. 1 shows a ray of light from the point (y=h, x=0) in the object that passes through the lens at a point defined by its polar coordinates (s,θ) will intersect the image surface at (x′, y′), where x′ & y′ can be generally described by formulae (1) & (2)

FIG. 2 shows an optical system consists of M point light sources with equal illuminance, and an image chip with N pixels.

FIG. 3 shows a proposed set-up for measuring the Point-Spread-Functions of the lens system. Shine collimated light on an opaque plate with small holes as point-like light sources, measure the image with high resolution image chip. The S matrix can then be constructed.

FIG. 4 shows one example of the opaque plate with small holes, the hole separations are smaller as they are further away from the center.

FIG. 5 shows another example of measuring the Point-Spread-Functions using opaque plate with small holes (or transparent plate with circular dark patterns.)

FIG. 6 shows the mathematical approximations of Point-Spread-Function.

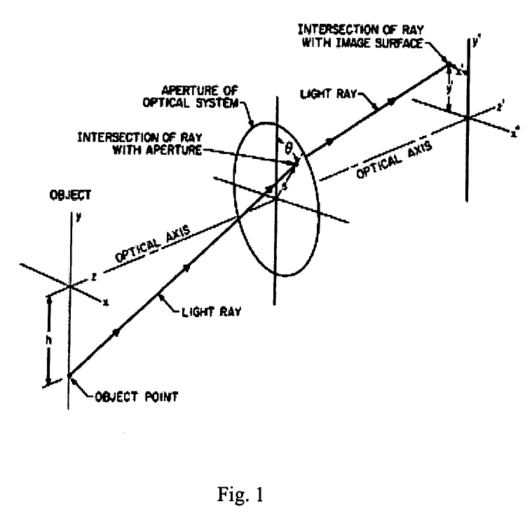

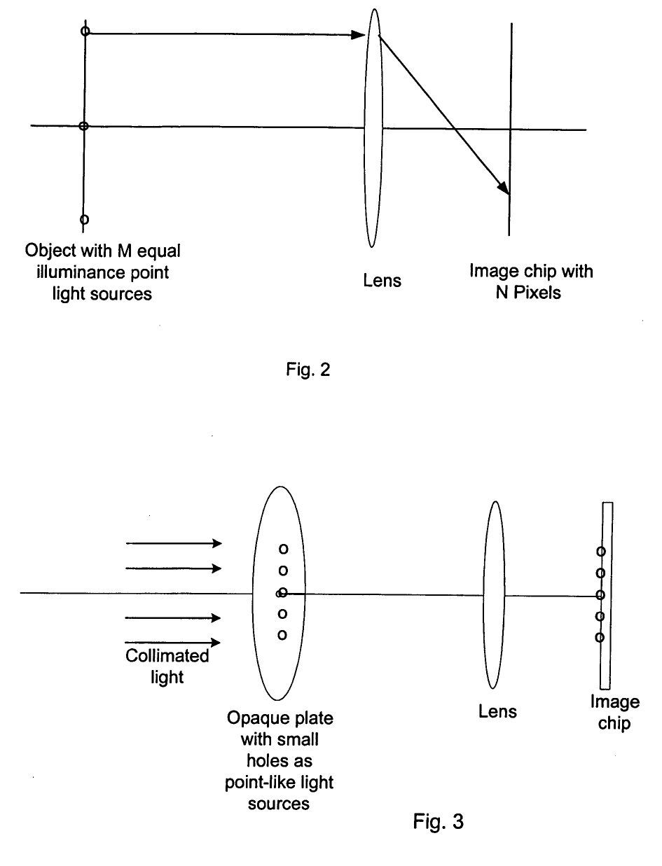

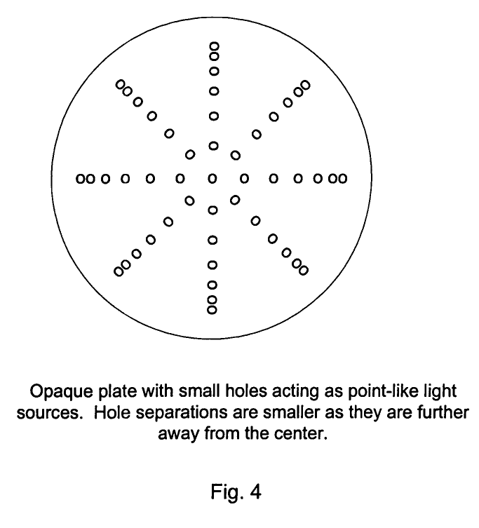

1. A revolutionary method of optimizing the optical system design to reduce the cost and size of the system comprising:
Relaxing the aberration specifications of the lens, thus reducing the number of lens which leads to less cost and smaller size.
Measure the Point-Spread-Function of some sample point objects with equal illuminations, and extract the aberration information of the lens.
Store the extracted aberration information of the lens in the image chip. Use some mathematical algorithm to process the raw image sensed by the image chip, thus creating the image with the lens aberrations corrected.

2. The method described in item 1. can also be used to build higher resolution optical systems using existing lower resolution lens. Simply measure the Point-Spread-Function of some sample point objects with equal illuminations, and extract the aberration information of the lens. Then store the aberration information of the lens in the image chip. Use some mathematical algorithm to process the raw image sensed by the image chip, thus creating the image with the lens aberrations corrected.

3. The above mentioned method can also be used to process the images taken by existing optical systems like digital camera etc. to get rid of some lens aberrations. Take the images of some sample point objects with equal illumination, which can be used to extract the aberration information of the lens. And use the same mathematical algorithm mentioned in items 1. & 2 to correct the lens aberrations.

4. The method of “Measure the Point-Spread-Function of some sample point objects with equal illumination” mentioned in item 1. & 2. referes to taking the images of some pre-designed point light sources with equal illumination using high resolution image chips. This is done for three colors: Red, Green and Blue.

5. One proposed set-up of the “point objects with equal illumination” or “point light sources with equal illumination” mentioned in items 1. to items 4 is shown in FIGS. 3 & 4. Use uniform collimated light source to shine on an opaque plate with hole patterns.

6. The hole size of the “opaque plate with hole patterns” mentioned in item 5 should be small enough so that the central bright spot of its image is less than the pixel size of the image chip.

7. The hole separations of the “opaque plate with hole patterns” mentioned in item 5 are smaller as the holes are further away from the center of the plate. This is because the distortions are bigger as the point object is further away from the center. Therefore, more data points are needed to extract the Point-Spread-Function.

8. The “mathematical algorithm” mentioned in items 1 to 3 refers to the formulae 3 & 4 in the “summary of invention” section. Where vector I is the illuminations of all the image pixels, O is the illuminations of all the object light sources, and S is the matrix describing the transformation of images. The S matrix is determined from the images of the “sample point objects” described in items 4 to 7.

9. The S matrix mentioned in item 8 is constructed as follows: As illustrated in the “Summary of Invention” section, each column of the S matrix corresponds to the Point-Spread-Function of one point object. Since there are only a limited number of sample point light sources in the “opaque plate” mentioned in items 5 to 7, the Point-Spread-Functions in the rest of the matrix can be constructed using linear extrapolating, that is, it can be taken as the average of the surrounding points.

10. The inverse S matrix S⁻¹ mentioned in item 8 will be saved in the image chips using non-volatile memory. The data is written during the final optical system test (with lens and image chips integrated).

11. Another proposed set-up of measuring the Point-Spread-Function of the lens consisting of taking the images of some uniformly separated circular light sources using high resolution image chips. This is done for three colors: Red, Green and Blue.

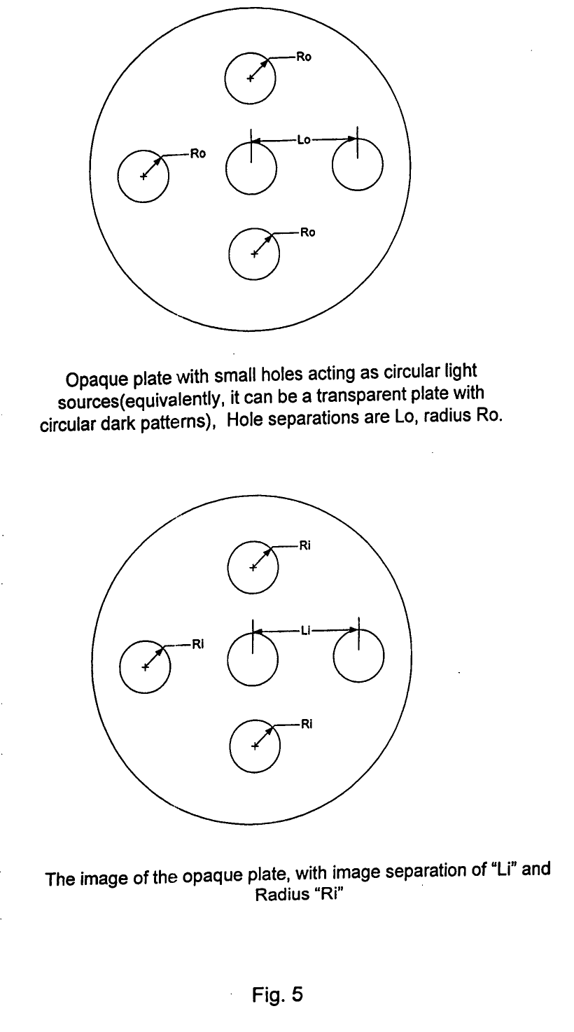

12. One example of “taking the images of some uniformly separated circular light sources using high resolution image chips” mentioned in item 1. is shown in FIG. 5. In which the light sources have separations of “Lo” and radius “Ro”, while their images have separations of “Li” and radius “Ri”

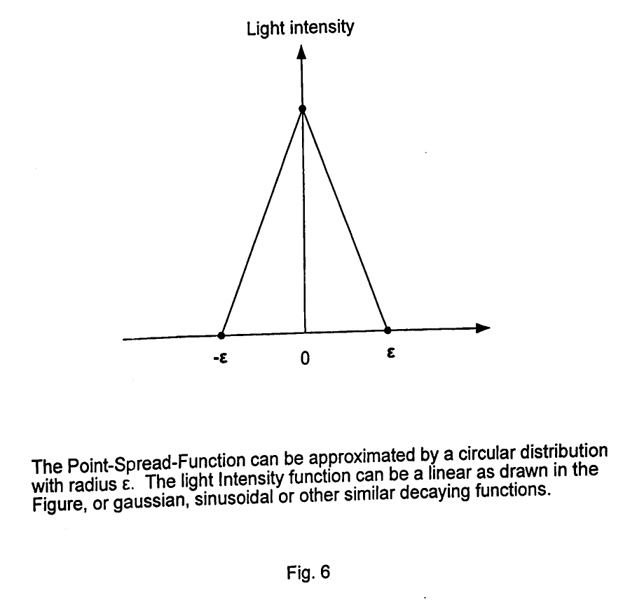

13. The Point-Spread-Function can be approximated by a circular distribution with a radius ε as shown in FIG. 6. Where the function can be a linear function, gaussian or sine, or other similar decaying functions.

14. The “radius ε” of the Point-Spread-Function mentioned in item 13 can be calculated using the measured data in item 12. according to the formular:
ε=Ri−(Li/Lo)*Ro
Averages can be taken to make a more accurate extraction of ε
